(19) United States
(12) Patent Application Publication
(10) Pub. No.: US 2014/0201067 A1
(43) Pub. Date: Jul. 17, 2014

(54) SYSTEM AND METHOD FOR FACILITATING A TRANSACTION

(71) Applicant: Hooko Limited, Kwun Tong (HK)

(72) Inventors: Jacky Hin Hang Lai, Sai Kung (HK); Charles Tsun Yin Yen, Ho Man Tin (HK)

(21) Appl. No.: 13/740,479

(22) Filed: Jan. 14, 2013

(51) Int. Cl. G06Q 20/22

(52) U.S. Cl. CPC G06Q 20/29
USPC 705/39

(57) ABSTRACT

A system and method for facilitating a transaction comprises a payment gateway arranged to receive a group payment request arranged to identify a plurality of users each contributing a payment portion to a total balance of the transaction, a generating module arranged to generate a part payment request for each plurality of users with the payment portion, a payment interface arranged to transmit the part payment request to each plurality of users, a settlement interface arranged to receive part payment instructions from each plurality of users to settle each part payment request, a settlement module arranged to settle the part payment instructions to determine a combined settled amount, and, a processor arranged to determining an outstanding balance by comparing the combined settled amount with the total balance; whereupon an outstanding balance is determined, selecting a user from the plurality of users and settling the outstanding balance with the selected user.

### TECHNICAL FIELD

This invention relates to a system and method for facilitating a transaction, and particularly, although not exclusively, to a system which facilitate a transaction whereby the transaction can be shared with one or more users.

### BACKGROUND

Users of merchant services such as purchasers of goods and services may conduct their purchases, either for business or pleasure, in groups of people or as an agent on behalf of some other persons. In these situations, a group of purchasers can simply approach a merchant with a sum of cash, followed by dividing the sum charged by the merchant amongst themselves so as to share the costs of the purchase, where as in the situation where a purchase was made on behalf of another person, an agent for the purchaser can make the payment first, then followed by chasing up the purchaser to obtain their money back.

Whilst the usage of cash offers an opportunity for these types of purchases to be resolved by the sharing and payment of costs between each of the parties, cashless payment systems are increasingly popular due to the increasing spread and security of electronic communications networks. However, existing cashless transaction systems are not adapted for group purchases or for an agent acting on behalf of a purchaser as these systems are focused and structured around the provision of a transaction between an actual purchaser and a merchant. In any event, should existing payment systems be used for group purchases or agent purchasers, problems relating to security, privacy and accountability will arise as payment systems are built around individual accounts and singular transactions.

### SUMMARY OF THE INVENTION

In accordance with a first aspect of the invention, there is provided a method for facilitating a transaction comprising the steps of:
receiving a group payment request arranged to identify a plurality of users each contributing a payment portion to a total balance of the transaction;
generating a part payment request for each of the plurality of users with the payment portion;
transmitting the part payment request to each of the plurality of users;
receiving part payment instructions from each of the plurality of users to settle each of the part payment request;
settling the part payment instructions to determine a combined settled amount; and,
determining an outstanding balance by comparing the combined settled amount with the total balance and; whereupon an outstanding balance is determined, selecting a user from the plurality of users and settling the outstanding balance with the selected user.

In an embodiment of the first aspect, the plurality of users includes an initiating user and one or more co-users.

In an embodiment of the first aspect, the group payment request is received from the initiating user.

In an embodiment of the first aspect, the group payment request includes a plurality of identifiers each being associated with at least one of the plurality of users.

In an embodiment of the first aspect, the plurality of identifiers includes phone numbers.

In an embodiment of the first aspect, the group payment request includes details associated with the transaction.

In an embodiment of the first aspect, the part payment request includes the payment portion associated with each of the plurality of users

In an embodiment of the first aspect, the part payment instructions include a reference to the user's payment facility.

In an embodiment of the first aspect, the step of settling the part payment instructions further includes contacting a bank or financial institution to action the payment instruction.

In an embodiment of the first aspect, the selected user is the initiating user.

In an embodiment of the first aspect, the group payment request is received from a merchant.

In accordance with a second aspect of the present invention, there is provided a system for facilitating a transaction comprising:
a payment gateway arranged to receive a group payment request arranged to identify a plurality of users each contributing a payment portion to a total balance of the transaction;
a generating module arranged to generate a part payment request for each of the plurality of users with the payment portion;
a payment interface arranged to transmit the part payment request to each of the plurality of users;
a settlement interface arranged to receive part payment instructions from each of the plurality of users to settle each of the part payment request;
a settlement module arranged to settle the part payment instructions to determine a combined settled amount; and,
a processor arranged to determining an outstanding balance by comparing the combined settled amount with the total balance and; whereupon an outstanding balance is determined, selecting a user from the plurality of users and settling the outstanding balance with the selected user.

In an embodiment of the second aspect, the plurality of users includes an initiating user and one or more co-users.

In an embodiment of the second aspect, the group payment request is received from the initiating user.

In an embodiment of the second aspect, the group payment request includes a plurality of identifiers each being associated with at least one of the plurality of users.

In an embodiment of the second aspect, the plurality of identifiers includes phone numbers.

In an embodiment of the second aspect, the group payment request includes details associated with the transaction.

In an embodiment of the second aspect, the part payment request includes the payment portion associated with each of the plurality of users

In an embodiment of the second aspect, the part payment instructions include a reference to the user's payment facility.

In an embodiment of the second aspect, the settlement interface further includes a routine arranged to contact a bank or financial institution to action the payment instruction.

In an embodiment of the second aspect, the selected user is the initiating user.

In an embodiment of the second aspect, the group payment request is received from a merchant.

In accordance with a third aspect of the present invention, there is provided a system for a merchant arranged to operate with a system in accordance the second aspect.

In accordance with a fourth aspect of the present invention, there is provided a method for facilitating payment comprising the steps of:
receiving one or more payment request from a merchant;
determining the identity of one or more users; and,
transmitting the one or more payment requests to the one or more users for settlement.

In an embodiment of the fourth aspect, the payment request is arranged to be transferable to one or more external parties.

### BRIEF DESCRIPTION OF THE DRAWINGS

Embodiments of the present invention will now be described, by way of example, with reference to the accompanying drawings in which:

FIG. 1 is a schematic block diagram of a computer server for use with one embodiment of the present invention;

FIG. 2A is a block diagram of the components of an example embodiment of a system for facilitating a transaction;

FIG. 2B is a block diagram of the system in FIG. 2A of an example embodiment of a system for facilitating a transaction in operation;

FIG. 2C is a block diagram of the system in FIG. 2A of an example embodiment of a system for facilitating a transaction in providing a group transaction;

FIG. 3 is a flow diagram of the operation of an embodiment of the system for facilitating a transaction;

FIG. 4 is a flow diagram of the operation of another embodiment of system for facilitating a transaction;

FIG. 5 is a flow diagram of the operation of another embodiment of system for facilitating a transaction;

FIG. 6A is a flow diagram illustrating the flow of funds in the operation of one embodiment of system for facilitating a transaction;

FIG. 6B is a flow diagram illustrating the flow of funds in the operation of another embodiment of system for facilitating a transaction;

FIG. 6C is a flow diagram illustrating the flow of funds in the operation of another embodiment of system for facilitating a transaction;

FIG. 7A is a flow diagram of one embodiment of a merchant system of a system for facilitating a transaction;

FIG. 7B is a flow diagram of another embodiment of a merchant system of a system for facilitating a transaction;

FIG. 7C is a flow diagram of yet another embodiment of a merchant system of a system for facilitating a transaction;

FIGS. 8A to 13B are screenshots of an example interface of an Application of the system for facilitating a transaction; and

FIG. 14 is a block diagram of a payment collection system which includes the use of an embodiment of the server of FIG. 1.

### DETAILED DESCRIPTION OF THE PREFERRED EMBODIMENT

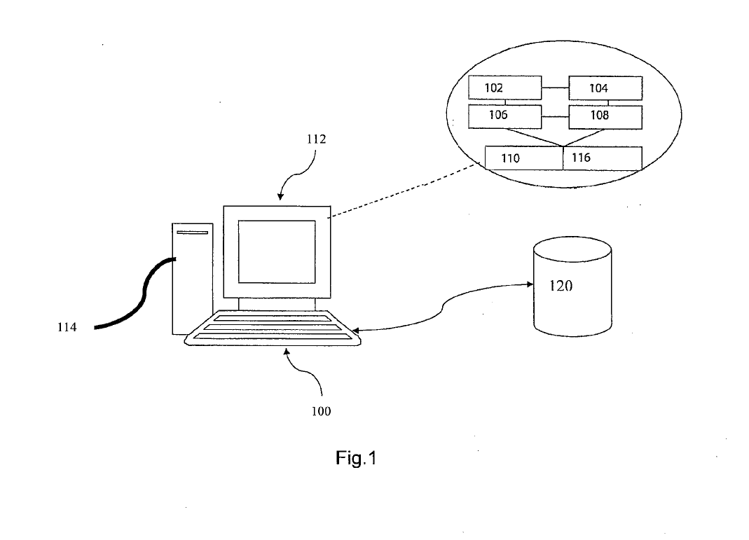

Referring to FIG. 1, there is shown a computer server 100 being arranged to operate as part of an embodiment of the present invention. In this embodiment, the server 100 is arranged to be implemented so as to provide the necessary data processing, management, communication and storage so as to provide a system for facilitating a transaction comprising: a payment gateway arranged to receive transaction information associated with a transaction between a merchant and an initiating user; a generating module arranged to generate a payment request related to the transaction and a payment interface arranged to transmit the payment request to the initiating user, wherein the payment request is arranged to be transferable to one or more co-users for settlement with a settlement interface.

In another embodiment, the server 100 is arranged to be implemented so as to provide the necessary data processing, management, communication and storage so as to provide a system for facilitating a transaction comprising:
a payment gateway arranged to receive a group payment request arranged to identify a plurality of users each contributing a payment portion to a total balance of the transaction;
a generating module arranged to generate a part payment request for each of the plurality of users with the payment portion;
a payment interface arranged to transmit the part payment request to each of the plurality of users;
a settlement interface arranged to receive part payment instructions from each of the plurality of users to settle each of the part payment request;
a settlement module arranged to settle the part payment instructions to determine a combined settled amount; and,
a processor arranged to determining an outstanding balance by comparing the combined settled amount with the total balance and; whereupon an outstanding balance is determined, selecting a user from the plurality of users and settling the outstanding balance with the selected user.

In this example embodiment, the payment gateway, generating module, the settlement module, the settlement interface, the payment interface, and the processor arranged to determine an outstanding balance by comparing the combined settled amount with the group balance are implemented by or on a computer or computing device having an appropriate user interface. The computer may be implemented by any computing architecture, including stand-alone PC, client/server architecture, “dumb” terminal/mainframe architecture, multiple processing nodes network or any other appropriate architecture. The computing device may also be appropriately programmed to implement the invention.

In this embodiment as shown in FIG. 1, the system for facilitating a transaction is at least partially implemented on a computer server 100 which is arranged to operate on a telecommunication network such as the Internet or any other telecommunication network so as to communicate with users, merchants, banks, credit facilities, clearing houses and/or any other interested parties to facilitate the transactions. In this example embodiment, the server 100 may be programmed with computing instructions or code so as to operate its underlying computing hardware to perform each of the functions of the payment gateway, the settlement module the settlement interface, the payment interface and the processor so as to perform the steps of the system for facilitating a transaction. Alternatively, the server 100 may be implemented or programmed so that parts of the system for facilitating a transaction, including any one or more of these components of the payment gateway, the settlement module the settlement interface, the payment interface and the processor are arranged to operate on another server, or on an alternative server remotely located from the server 100.

Referring to FIG. 1 there is a shown a schematic diagram of a server 100 implemented to operate as a system for facilitating a transaction. In this embodiment, the server 100 comprises suitable components necessary to receive, store and execute appropriate computer instructions. The components may include a processing unit 102, read-only memory (ROM) 104, random access memory (RAM) 106, and input/output devices such as disk drives 108, input devices 110 such as an Ethernet port, a USB port, etc. Display 112 such as a liquid crystal display, a light emitting display or any other suitable display and communications links 114. The server 100 includes instructions that may be included in ROM 104, RAM 106 or disk drives 108 and may be executed by the processing unit 102. There may be provided a plurality of communication links 114 which may variously connect to one or more computing devices such as a server, personal computers, terminals, wireless or handheld computing devices. At least one of a plurality of communications link may be connected to an external computing network through a telephone line or other type of communications link.

The service may include storage devices such as a disk drive 108 which may encompass solid state drives, hard disk drives, optical drives or magnetic tape drives. The server 100 may use a single disk drive or multiple disk drives. The server 100 may also have a suitable operating system 116 which resides on the disk drive or in the ROM of the server 100.

The system has a database 120 residing on a disk or other storage device which is arranged to store, either temporarily or permanently, used, received, generated or otherwise recorded data during its operation as a system for facilitating a transaction or its operation to perform the steps of a method for facilitating a transaction.

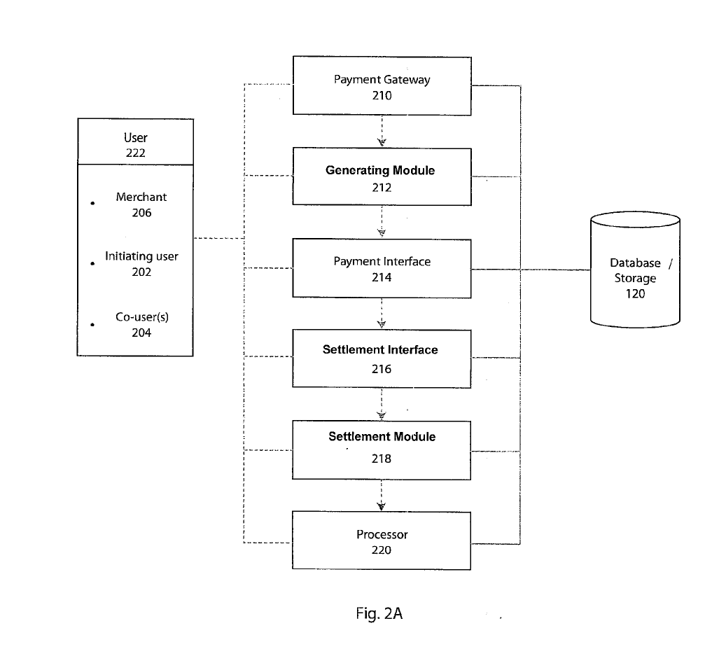

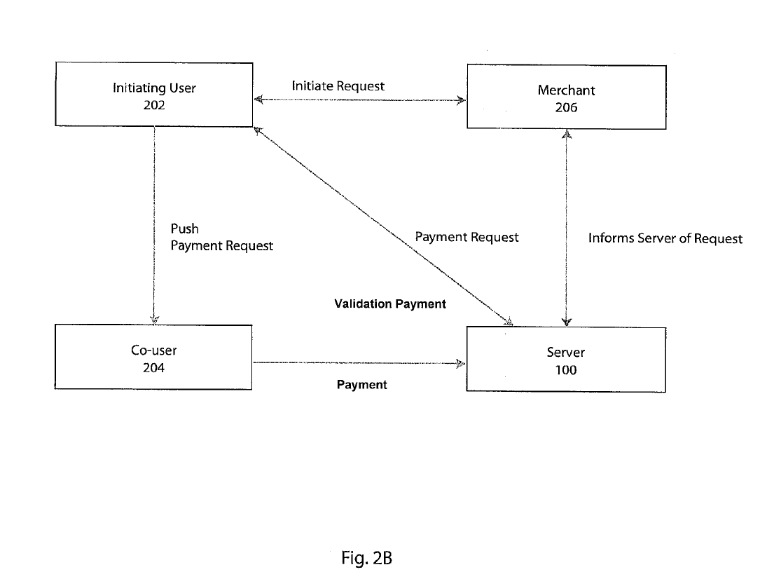

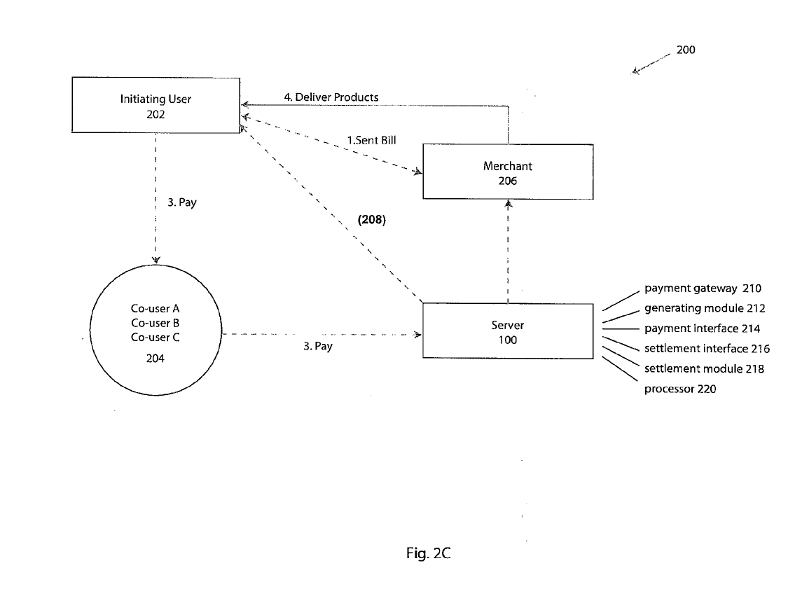

With reference to FIG. 2A, there is illustrated a block diagram of a system for facilitating a transaction. In this embodiment, the system comprises a payment gateway 210, generating module 212, payment interface 214, settlement interface 216, settlement module 218, a processor 220 and a database 120. In this embodiment, each of these components may be implemented in software, hardware or a combination of both and operated on a server connected to a communication network such as the internet so as to perform the method steps of facilitating a transaction, although in some other embodiments, portions of these modules may be implemented on a computing device of another party of the transaction, including the merchant, initiating user and one or more co-users.

As shown in FIG. 2A, each of the modules, gateways or interface 210 to 220 may be arranged to communicate with one or more users 222, including an initiating user, merchant or one or more co-users. Preferably, the communications between each of the user is conducted via the communication network on computing devices such as smart phones, portable computers, laptops, point of sales devices or other computing devices which may be used by any of the users 222.

With reference to FIG. 2B, there is illustrated a block diagram of a system for facilitating a transaction 200. In this embodiment, the server 100 having the modules, interfaces and processors described in FIG. 2A is implemented to operate on a telecommunication network so as to communicate with the initiating user 202, one or more Co-users 204 and a merchant 206 to facilitate a transaction between the initiating user 202, one or more co-users 204 and the merchant 206.

In this example, when an initiating user 202 approaches a merchant to participate in a transaction, the merchant 206 may then proceed to contact the server 100 to notify the server 100 that a transaction is about to take place between the merchant 206 and the initiating user 202, although, as a person skilled in the art would appreciate, this communication can also take place between the initiating user 202 and the server 100. Preferably, the merchant transmits transaction information associated with the transaction to the server 100 which may include one or more of:
an identifier of the initiating user 202 such as a phone number, email address or user ID;
a transaction identifier, such as a transaction ID code to identify the transaction;
a merchant identifier to identify the merchant;
the transaction amount; and
other information relating to the transaction, such as item descriptions and quantities.

Once the transaction information is sent to the server 100, the server 100 may then proceed to send a payment request to the initiating user 202. This payment request may be in the form of a data packet which is communicated to the initiating user's 202 smart phone or computing device. Upon receiving the payment request, the initiating user 202 may then proceed to settle the payment, or, to transmit the payment request to one or more co-users 204 for settlement by each of these one or more co-users.

Preferably, in order to facilitate the ability to transfer the payment request from the initiating user 202 to the one or more co-users 204, the payment request includes information relating to the transaction, such as information which is found in the transaction information described above. This allows the payment request to be pushed or transmitted to another party such as a co-user 204 for settlement without the co-user 204 being made known to the merchant 206. Once a payment request is transmitted to a co-user 204, in one example, the co-user 204, having the information relating to the transaction, can then proceed to contact the server 100 and settle the payment request through the settlement interface 216.

In this embodiment, the co-user 204 may also be given the option to settle only part of the total transaction amount of the payment request. This would allow the co-user 204 to make a part payment to the payment request. In examples where there are numerous co-users 204, each co-user 204 may be arranged to contribute a part payment to the payment request until the entire transaction amount is settled. In this example, the system 100 may also be arranged to conduct a validation process on the initiating user 202 before the transaction is allowed to take place. This validating process may include a query as to the financial details, status or banking information of the initiating user 202 to ensure that the user 202 can pay the total transaction amount of the transaction with the merchant. The purpose of this validation process is to ensure that in the event the one or more co-users 204 do not settle the full transaction amount, any differences or outstanding amounts can be charged onto the initiating user 202. Once validated, the initiating user 202 can also divide the transaction amount in the payment request into specific portions for payment by each of the co-users 204 and him or herself.

The abovementioned embodiments with reference to FIG. 2B may be advantageous in situations where there is a desire to transfer, transmit or push a payment request to another person for settlement. As an example, where an agent purchases an item or service with a merchant, the agent can simply push or transfer the payment request from the merchant to another person, who may be the actual purchaser or group of purchasers. In this case, by allowing the payment request to be transferable for payment by external person who may not be present when the transaction is undertaken, a transaction may be conducted more freely, particularly between parties such as agents or representatives of a purchaser to a merchant without the agent having to be concerned as to obtaining funds in advance from a purchaser or a risk that the purchaser does not pay the agent back in the future.

With reference to FIG. 2C, there is illustrated a block diagram of a system for facilitating a transaction 200. In this embodiment, the server 100 is implemented to operate on a telecommunication network so as to communicate with the initiating user 202, Co-users 204 and a merchant 206 to facilitate a transaction between the initiating user 202, one or more co-users 204 and the merchant 206.

In this example, when a initiating user 202 and his or her co-users 204 enter into a group transaction with the merchant, which for example may include a transaction where the merchant is expecting a payment for a purchase, but the purchase price is to be distributed to a plurality of users for settlement (e.g. including initiating user 202 and a one or more co-users 204), the initiating user 202 may then firstly be prompted to initiate this group transaction with the merchant by using a smart phone or other computing device having an appropriately programmed Application to contact the server 100 and submit a group payment request (208) to the server 100 for processing.

Preferably, the group payment request (208) is a data packet or other forms of data communication which includes at least information associated with the transaction with the merchant and the identities of at least one of the purchasers. In other examples, the Application on the initiating user's smart phone or computing device 202 may include a billing module which is arranged to collect transaction details relating to the group purchase. This information may be collected from the merchant through a communication link or scanning of a barcode/QR code or alternatively, input by the initiating user. Once the details relating to the transactions are entered into the billing module, the billing module may allow the bill to be split or divided amongst all of the purchasers, including the initiating user 202 and the one or more co-users 204. In some embodiments, the billing module may be able to split the amount due for the transaction and itemise each charge for distribution to all the purchasers or simply evenly distribute the charges. All of this information may then be packaged into a group payment request (208). Accordingly, depending on the manner in which the users wish to conduct the group transaction, the group payment request (208) may include for example:
a transaction reference which can be used to refer to the transaction being processed by the merchant as part of the group purchase;
identification information of one or more purchasers, this may include identification of the initiating user 202 or any one or more of co-users 204 if known. The identification may include email address, phone numbers, avatars or user ids etc;
the part payments due for each of the co-users;
identification of the merchant;
references and details associated with the transaction being conducted between the merchant and the purchaser user 202 and his or her co-users 204, this may include a listing of goods and services purchased and their respective prices or charges; and/or
the total amount of monies for the transaction.

Once the group payment request (208) is transmitted to the server 100 from the initiating user 202, a payment interface implemented on the server 100 may then proceed to communicate with the each of the co-users 204 to notify them of a part payment request if the identities of each of the co-users 204 were submitted by the initiating user 202 in the group payment request (208). In some embodiments, where the identities of the co-users 204 were not provided in the group payment request (208) the payment interface may contact the merchant for the identifies of any co-users 204 as the co-users 204 may inform the merchant at the point of sales. Alternatively, the payment gateway may request the initiating user 202 to make contact with each of the co-users 204 and instruct each of them to contact the payment gateway so as to be registered to be part of this group transaction. In these instances, a reference ID, such as a transaction ID may be needed to be supplied to each of the co-users 204 so that the payment gateway is able to associate each of the co-users 204 with the appropriate group transaction.

After initiating the transaction, the initiating user 202 can then proceed to make a payment for his or her share of the total amount of the group transaction by immediately settling the amount due by the initiating user. Preferably, the Application running on the initiating user's smart phone or computing device may already have credit or banking information which would facilitate this process, such as the inclusion of credit card or bank account details. Depending on the instrument used, the Application on the initiating user's smart phone or computing device may then proceed to contact the server 100 and supply this payment instruction so that settlement can be action for the initiating user's share of the group transaction. This settlement process may be actioned by a settlement module on the server 100 or by communication with an appropriate credit card facility, bank or clearing house gateway.

Once the co-users 204 receives a part payment request on their smart phone or other forms of computing device which they are operating, either from the server 100, the initiating user's 202 device or the merchant 206, each of the co-users 204 can then proceed to make a payment to settle their part payment request. Preferably, each of the co-users 204 would also have an Application installed on their smart phone or computing device which would include their financial details with a banking institution or credit facility so as to facilitate the settlement of the part payment in a similar manner as the way in which the initiating user 202 had settled his or her share of the group transaction. In one preferable example, each of the co-users 204 may have their credit card or bank account details stored on their Application in which once they receive a part payment request, they are able to adjust or approve the amount and settle this part payment request through their bank account or credit card facility.

In some embodiment, the part payment request is settled by each of the co-users 204 by each of the co-users 204 submitting a payment instruction to the server 100. In these examples, the payment instruction may include the relevant banking or credit card details as well as the associated transaction ID and the identity of the co-user 204. In these embodiments, the server 100 is implemented with a settlement module arranged to settle the charges with the merchant. Once each of the co-users 204 performs their settlement of their associated part payment, a comparison is conducted by the server 100 to determine if there are any outstanding amounts not yet settled. In the event where one or more of the co-users 204 have not settled their payment requests, the outstanding amount may be passed onto the initiating user 202 for their settlement. This will result in the initiating user 202 being charged more than their share of the group transaction but also guarantees that the merchant is able to receive the full amount of monies owning as part of the group transaction.

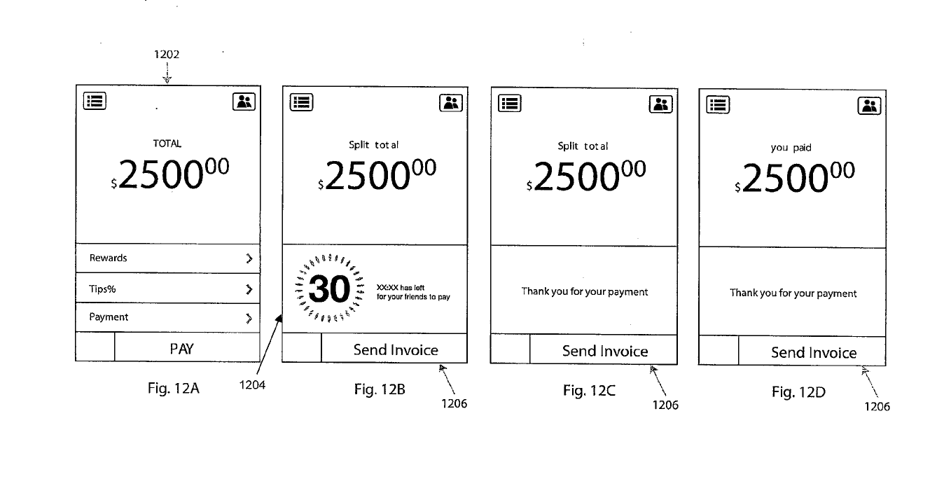

In order to enhance the transaction experience between the initiating user 202, the co-users 204 and the merchant, the initiating user 202 may be required to give a guarantee to the server 100 so as to be certain that the full amount of the group transaction will be settled. This provides a level of reassurance to the merchant and may be achieved by ensuring that the initiating user 202 provides a suitable credit card or banking facility reference which will guarantee settlement with the merchant. Therefore, once this guarantee is provided, the merchant is able to provide the goods or services for the initiating user 202 and the co-users 204 without waiting for each of the co-users 204 to settle their associated part payment request. In this example, the initiating user 202 may then provide a pre-determined amount of time to each of the co-users 204 to settle the part payment request, including the transmission of reminders to each of the co-users 204. An example of a reminder is shown with reference to the screenshot shown in FIG. 12B below.

These embodiments of the system for facilitating a transaction is advantageous in that the system facilitates transactions where there are a group of purchasers whilst also ensuring that the merchant does not need to manage or process individual transactions with each of the purchasers. In many social situations such as dining out with a group of friends or the purchase of a gift by a group of people, the costs of purchase can be shared between a group of people electronically without the merchant having to be concerned with the processing of individual transactions, which is very time consuming. In addition to this advantage, the system also provides for a guarantor which ensures a merchant will always be paid the full amount for the purchase even though the purchase price is to be shared by a group of people and a reminder system so that any outstanding amounts can be tracked by users of the group, thus minimizing awkward discussions over monies incurred over a particular transaction.

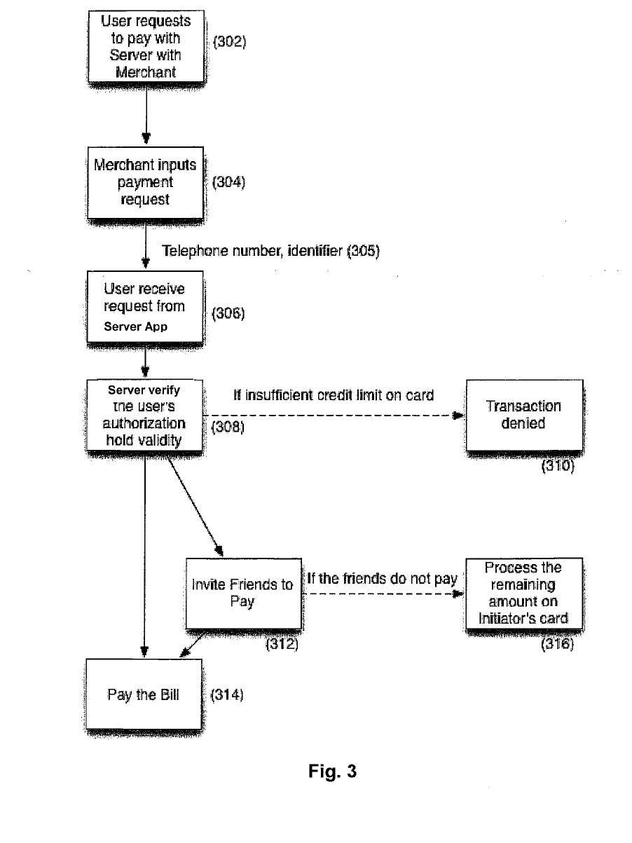

With reference to FIG. 3, there is provided a data flow diagram illustrating each step of a process whereby a group purchase is made between a merchant and a group of purchasers. In this example embodiment, the group of purchasers includes an initiating user 202 and his or her co-users 204 each arranged to interact with the server 100 to facilitate this group payment to a merchant.

As shown, once a group of purchasers decides to purchase a good or service from a merchant, the group of purchasers may select an initiating user (302) to communicate with the server 100 of the system for facilitating this group transaction. This may be done by the use of a smart phone or computer application implemented on a smart phone or a computing device in which the selected initiating user can make a group payment request with the server 100. Simultaneously, the merchant may also use their own computing devices, such as a Point of Sales (POS) systems or other computing device to communicate with the server 100 so as to provide details of the transactions to the server (304).

In order to ensure the correct transaction is referenced to the group of purchasers, the merchant may request the selected initiating user to provide a telephone number, email address, user id or any other forms of identification information or identifier (305) so as to refer to the transaction. This identifier may also submitted by the merchant to the server 100 so that the transaction reference can be verified. Once verified, the server 100 may then proceed to transmit a group payment request to the initiating user (306) which can then be used by the initiating user to select the identities of one or more co-users who will also contribute a portion of monies towards the group purchase with the merchant.

In this embodiment, once the initiating user receives the request from the server 100, the server 100 may then proceed to check whether the initiating user has sufficient amount of credit or authorization to be a guarantor for the transaction in the event that the co-users do not proceed to pay their associated portion of the monies towards the purchase with the merchant (308). In one example, this check could be conducted by contacting the initiating user's bank or financial institutions to determine whether the initiating user's financial status meets the necessary requirements of the transactions. In other examples, the initiating user may have pre-purchased credit with an authorized credit facility, in which case this authorized credit facility may be contacted by the server 100 for verification.

If the user fails the validation check, then the transaction is denied (310). However, if the initiating user is validated to be able to continue with the group purchase, the initiating user may then proceed to settle his or her share of the group purchase (314), whilst the other co-users will then be requested to settle their portion of the purchase. In one example, the server 100 is arranged to transmit a part payment request to each of the co-users for settlement (312). This may be completed by the transmission of a request via a smart phone or computer applications operated by a co-user. Upon the co-users receiving the part payment request, they can proceed to settle the part payment with their own credit or banking facilities which may be stored on their smart phone or computing devices (314).

In the event that one or more of the co-users do not settle their part payment request within a predetermined period of time, say for example 24 hours or some arbitrary figure set by the users, banks or merchants, the server 100 may then proceed to settle this outstanding amount with the initiating user (316). This outstanding amount may be determined by a comparison between all of the part payments received and the balance due to the merchant. The result of this is that the initiating user will pay more than their fair share in the group purchase, but guarantees that the merchant is able to receive their money. Once the outstanding amounts are settled, the server 100 may proceed to pay the merchant the full amount, or by contacting a bank, credit card facility, third party financial institution or clearing house to electronically transfer the moneys to the merchant.

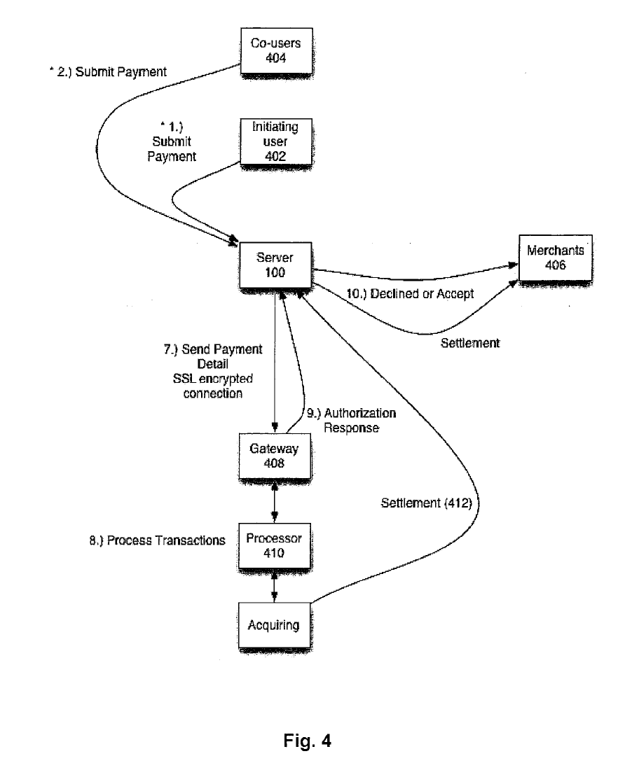

In other embodiments, the system for facilitating a transaction may take a different form than the processes and data flow as illustrated and described with reference to FIGS. 2 and 3. This is because the generation and transmission of group payment requests, part payment requests, transaction details, merchant details and other data shared between each of the devices belonging to the server, merchant, initiating user, co-users, banks, financial institutions or clearing houses may be conducted in differing orders by any one of these parties to facilitate the transaction process. As an example, the initiating user may be able to contact each of the co-users directly through their smart phone or computer by generating and sending the part payment request whilst communicating this information to the server 100 and/or merchant. Alternative methods and locations of generation of payment requests may take place on any of the computing devices or smart phones within the system for facilitating a transaction. Non exhaustive examples of various alternative embodiments in which the system for facilitating a transaction would operate are shown with reference to FIGS. 4, 5, 6A to 6C

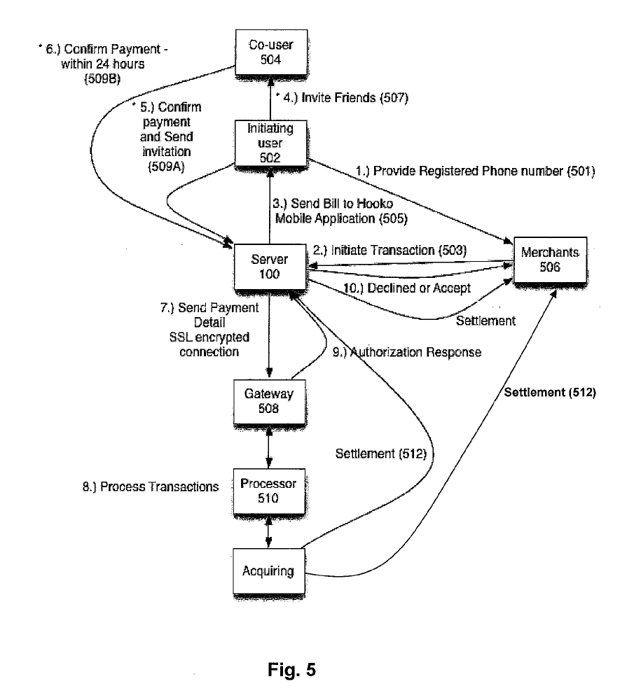

With reference to FIGS. 4 and 5, there is provided a flow chart illustrating the flow of funds from each of the users (initiating users 202 and co-users 204) to the merchant 206 in accordance with the operation of one embodiment of the present invention. In the embodiment of the invention as shown in FIG. 4, once a group transaction has been entered into between an initiating user 402 and his or her one or more co-users 404, an authorization of payment may then be made by the initiating user and the co-users with the server 100. Once the server 100 receives one or more these authorization of payment or payment instructions, the server 100 may then transmit these authorization or instructions, together with credit and banking details of each of the users to a payment gateway 408, which may be a generic gateway operated by a credit card provider, bank or clearing house which provides the service of credit or payment facilities through an electronic interface.

Once the payment gateway 408 receives the authorization or instructions for payment, the authorization or instructions for payment is processed by a processor 410 and a settlement process (412) is initiated. In the embodiments shown in FIG. 4, the settlement is conducted with the server 100 and thus the server 100 will have the total funds to pay the merchant 406. After this settlement occurs, the server 100 will than proceed to settle the transactions with the merchant 406 and thus completed the group transaction.

With reference to FIG. 5, there is shown an alternative embodiment in which funds are transferred to the merchant 506. In this embodiment, once a group transaction has been initiated, the initiating user 502 provides an identifier 501 to the merchant 506. This identifier 501 may be in the form of a phone number referencing the smart phone in which the initiating user 502 is using.

Once the merchant 506 receives this identifier 501, the merchant's computing systems may contact the server 100 to initiate the transaction (503). The server 100, having the identifier 501 of the initiating user 502 may then proceed to contact the initiating user 502 and transmit to the initiating user a payment request (505) associated with the group transaction initiated by the initiating user 502.

Upon receiving this payment request (505), the initiating user 502 can proceed to conduct two processes. The first process is to contact the other co-users 504 (507) who will take part in this group transaction with the merchant 506. This contact will be in the form of a part payment request which may, in one example, be generated by the initiating user 502 on their smart phones. Preferably, the initiating user 502 may also select the actual amounts to form each of the part payment requests. This is particularly advantageous in examples where each co-user 504 had incurred a different cost as part of the transaction such as in the situation of a restaurant setting where co-user A and co-user B had ordered different items and therefore had incurred different costs. In these examples, the initiating user 502 may be able to download details of the transactions from the server 100 of the merchant 506 and allocate a portion of the transactions to each of the co-users 504. Alternatively, the initiating user 502 can evenly distribute the costs to each of the co-users 504 and to himself or herself.

Once the part payment requests are sent to each of the co-users 504, the initiating user 502 may then proceed to settle his or her share of the transaction (509A), followed by each of the co-users 504 in settling their part of the payment request (509B). At this stage, both the initiating user 502 and the co-users 504 may send an authorization of payment to a gateway 508 of their credit card facility or bank for processing by a processor 510. To provide adequate time for all co-users to settle their associated part payment requests, a pre-determined time window, for example, 24 hours, is given to the co-users 504 to settle the part payments (509B).

To facilitate the completion of the transaction with the merchant 506, the initiating user 502 would, in some example embodiments, be checked to act as a guarantor for the transaction in the event that the co-users 504 do not settle their share of the part payment requests. In this case, the gateway 508 and the processor 510 may then proceed to check the financial status or credit limit of the initiating user 502. If this check reveals that the user is able to act as the guarantor, that is, they have sufficient funds or credit to guarantee the transaction, then the transaction is approved. However, if the financial status of the initiating user is not of a certain level, then the check would return a “decline” status, meaning that the transaction cannot continue unless an alternative person with adequate credit facility is able to act as the initiating user.

Once it is determined that an initiating user has adequate credit facility, the server 100 will than authorize the group transaction, in which case the merchant is notified of this success so as to complete the transaction. In due course, preferably after all the co-users are given a predetermined time period to make their part payment, the bank or financial institution is arranged to settle (512) the transaction with the merchant 506.

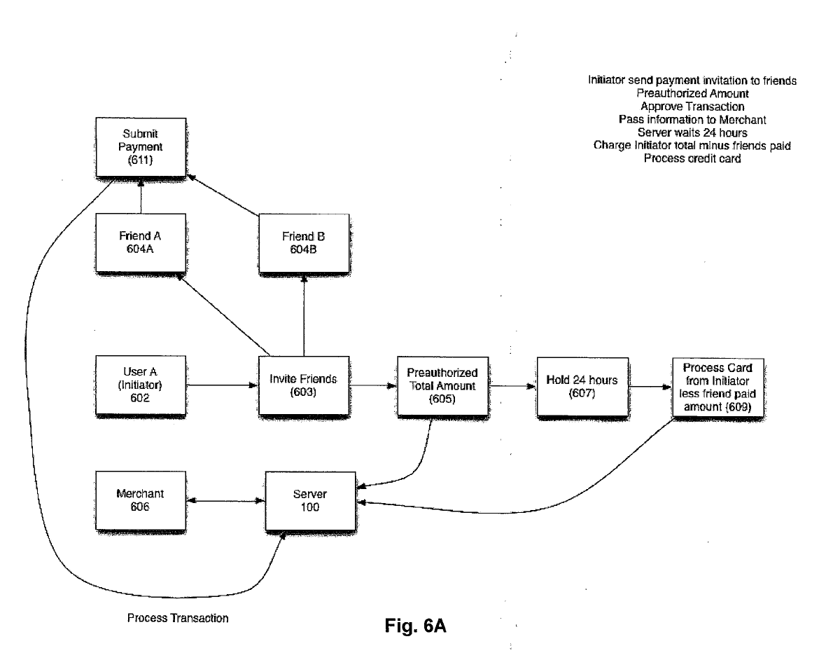

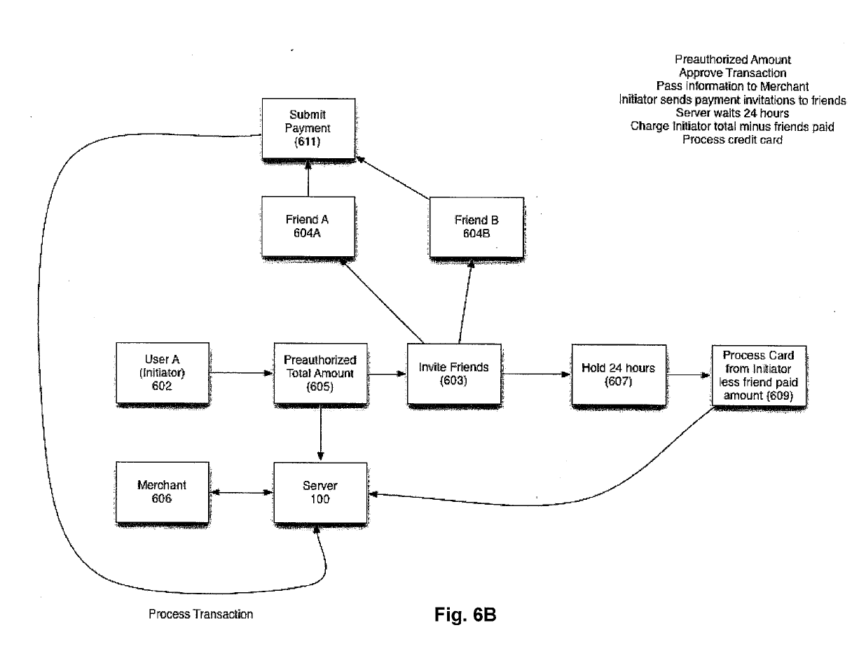

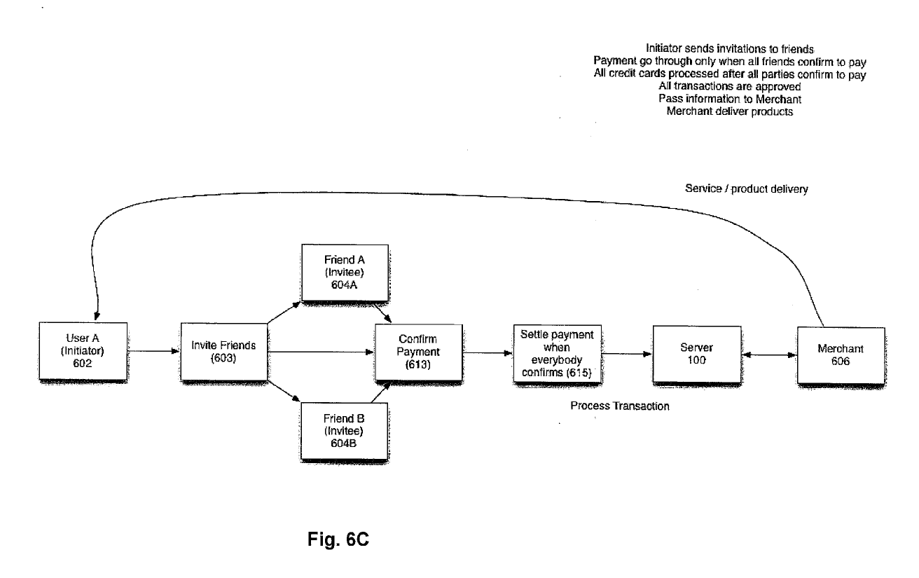

With reference to FIG. 6A to 6C, there is provided flow diagrams illustrating the manner in which funds are transferred between each of the parties in different alternative embodiment of the system for facilitating a transaction. As is shown in the embodiment of FIG. 6A, an initiating user 602 invites (603) a number of co-users 604A, 604B (friends A and B) to participate in a group transaction with a merchant 606 by firstly inviting his/her friends (the co-users). During this process, the initiating user would be checked (605) via a preauthorized total amount as to his or her eligibility to be a guarantor for this transaction in the event that the co-users do not pay their associated part payment.

Once the check is completed and the initiating user's eligibility is established, a predetermined time window (607), (e.g. 24 hours) is given for all of the co-users 604A, 604B to settle their respective part payments (611). Upon the expiration of the predetermined time window, the initiating user 602 is charged both his or her portion of the group transaction as well as any non payments from one or more co-users (609). The total payments are then provided to the merchant 606 for settlement.

In one embodiment as shown with reference to 6B which is similar to the embodiment of FIG. 6A, the initiating user 602 may under go checking with the server 100 for eligibility as the guarantor (605) before inviting (603) his or her friends to be co-users 604A, 604B. This is advantageous in some situations where the initiating user 602 is not yet aware of the complete list of the co-users 604A, 604B at the time of purchase, thus allowing the initiating user 602 to determine this list at a later time. In certain situations, such as in the retailing of goods, it may not be known to the initiating user 602 who will contribute to the costs of the goods at the time of purchase as other co-users may join or leave the group transaction, thus this embodiment is advantageous to the initiating user and subsequent co-users also when this situation arises.

With reference to FIG. 6C, there is provided a flow diagram illustrating an embodiment of the invention in which there is no validation of an initiating user 602 from being a guarantor for payment of the co-users 604A, 604B. As illustrated in this example embodiment, once the group transaction is initiated, the initiating user 602 and the co-users 604A, 604B are required to confirm payment (613) with the server 100 before the transaction is completed (615). This embodiment does not require validation or check of the financial status of an initiating user 602 and is particularly advantageous in situations where all of the co-users 604A, 604B are present in which case the transaction is not deemed to be finalised until all of the parties (initiating user and co-users) have settled the transaction (615) at the point of sales.

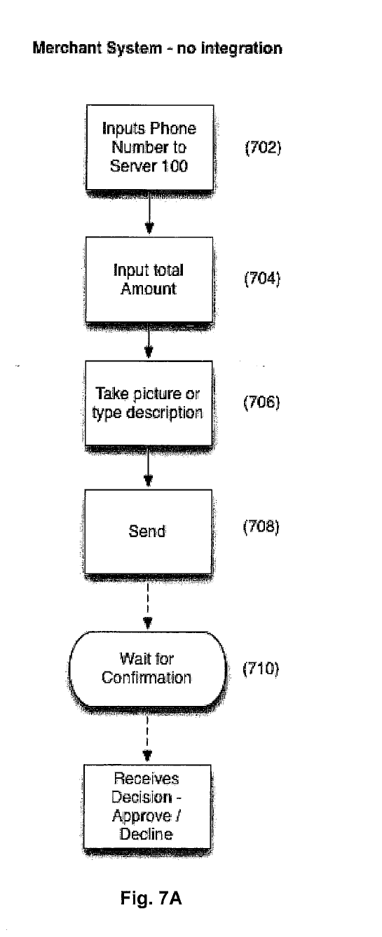

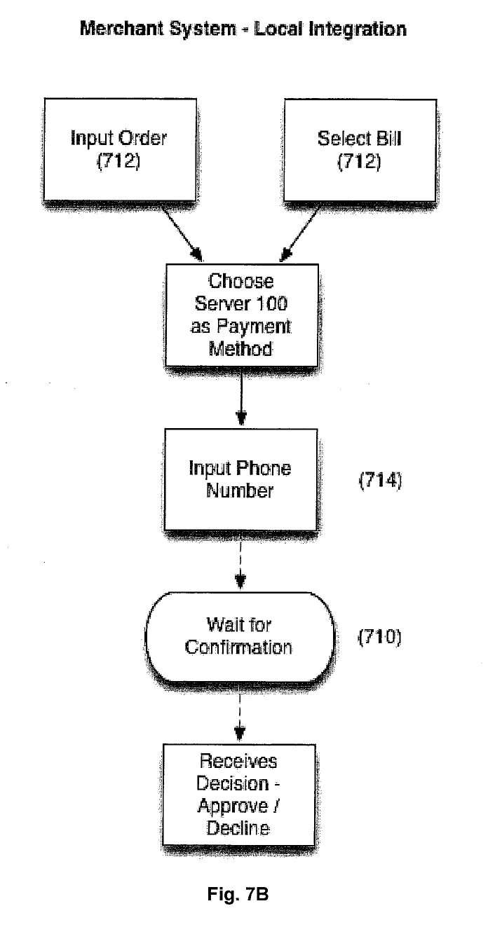

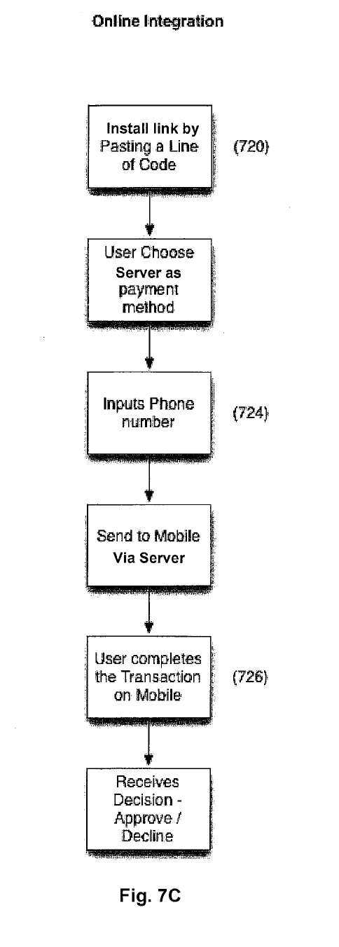

With reference to FIGS. 7A to 7C, there is provided a number of flow diagrams illustrating the flow of data and processing which occurs with a merchant arranged to operate with an embodiment of the system for facilitating a transaction. As the merchant will need to communicate with the server 100 and/or the initiating user, in some embodiments, the merchant may be required to operate a merchant system, which may be an appropriately programmed computing device, such as a Point of Sales system which is connected to the internet or other communication network.

In the embodiment shown in FIG. 7A, the merchant system is arranged to connect to the server 100 and will submit a phone number provided by an initiating user of a group transaction (702). Once the phone number is provided, the merchant may also provide the server with the total amount of the transaction (704) together with a description or photograph of the goods or services being purchased (706). Once this information is sent to the server 100 (708), the server will proceed to communicate with the bank/financial institution, credit facility and the initiating user to determine if the transaction is able to proceed after which the merchant can wait for a determination of whether the transaction can continue (710).

With reference to FIG. 7B, there is illustrated an alternative embodiment to a merchant system. In this embodiment, an input order or bill (712) is first entered into the point of sales system of the merchant before a phone number or other identifier is requested from the initiating purchaser (714). This alternative embodiment is particularly advantageous in certain usage situations such as restaurants where a large volume of purchase orders are previously entered into a purchasing or merchandising system before a payer would reach the point of sales as the time required to set up the group transaction is reduced.

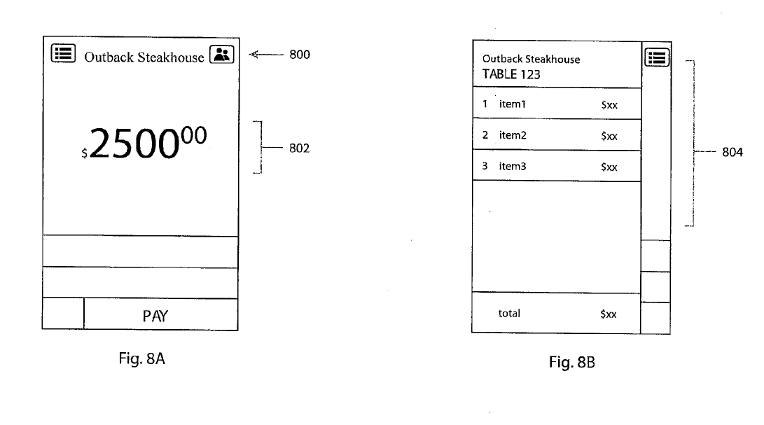

With reference to FIG. 7C, there is illustrated another alternative embodiment to a merchant system. In this embodiment, a merchant system may be in the form of an online e-business system whereby a payment portal is provided for a user to make a purchase over the internet or other forms of communication network. In this example, the merchant system, once initiated to use the server 100 for payment is arranged to install a plug in, link or application (720) to connect with the server 100 before a user is able to proceed with the transaction with the merchant. In this embodiment, a merchant may be an online e-business wherein the merchant includes a link to the server 100 in which a user can connect to in order to use the system for facilitating payment 200. Once installed on the merchant's system, a user can then proceed to submit an identifier such as a phone number (724) after which the server 100, being linked via the merchant, will than approach the user to settle the payment (726) as described with reference to FIG. 7A. With reference to FIGS. 8A to 13B, there is provided a series of screen shots of a smart phone interface 800 which is used by an initiating user 202 and co-users 204 in operating an embodiment of the system for facilitating a group transaction 200. Preferably, these smart phone interfaces are implemented as part of an Application which is arranged to operate on a computing device, such as a smart phone. These Applications, when operating on a smart phone may be referred to as an “app” which is arranged to be downloaded and stored as computer software for processing by a smart phone's processor so as to process/store data whilst also allowing a user to interact with the app through the smart phone interface such as a touch screen.

As shown in FIGS. 8A and 8B, whereupon an initiating user communicates with the merchant 206 to initiate a group transaction, the initiating user starts up a group payment application on his or her Smartphone. In this embodiment, the application is arranged to communicate with the merchant to download details associated with the transaction, including the total amount 802 and an itemized listing of the charges 804 which have been incurred as part of the group transaction. Once this information is received on the initiating user's application, the total amount as well as the itemized listing of the charges is presented to the initiating user for preview 802, 804.

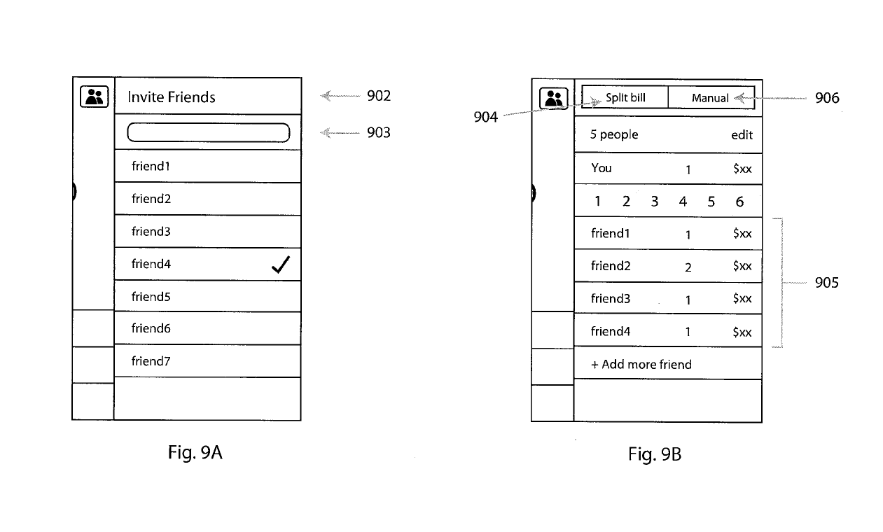

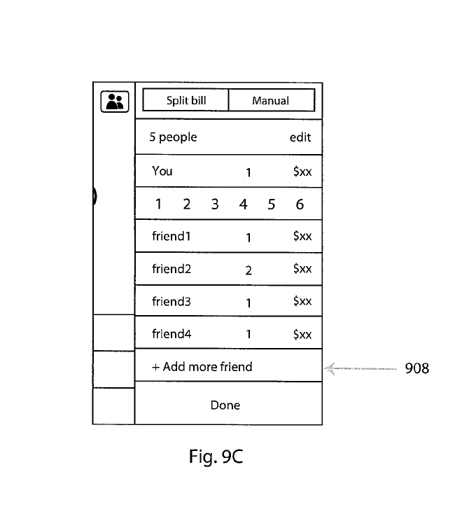

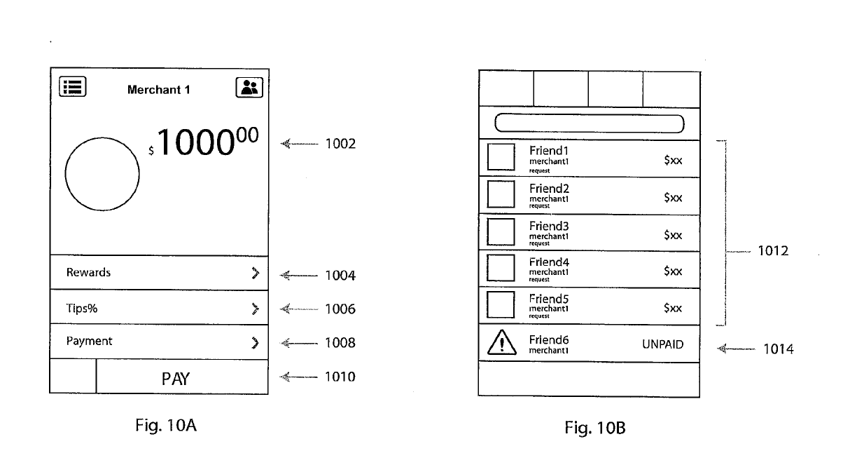

After reviewing this information, the initiating user may then proceed to invite co-users to contribute a part payment towards this group transaction. As shown in FIGS. 9A and 9B, the initiating user may then proceed to enter an “invite friends” screen 902 whereby the initiating user can select one or more co-users, or friends to contribute towards this group purchase. As shown in FIG. 9A, the co-users are invited by utilizing their phone number 903 although an identifying user ID or email can also be used to identify each of the co-users.

Upon selection of the co-users, the initiating user can then proceed to itemize the bill 905 for each of the co-users. As shown in FIG. 9B, the initiating user has the option of splitting the bill evenly 904, or manually 906 splitting the charges amongst all of the invited co-users. As shown in FIG. 9C, it is also possible to adjust the charges which will be contributed by the initiating user so as to meet the total amount to be settled with the merchant for this group purchase. As shown FIGS. 9B and 9C, at any time, the initiating user can add or remove other co-users to share the cost of the group purchase 908.

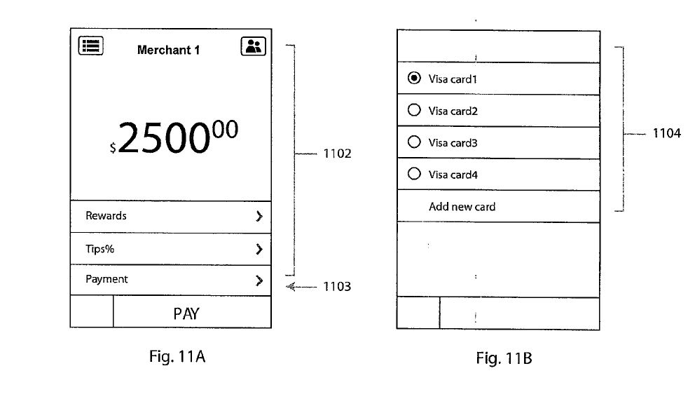

Once the total list of co-users and their associated part-payment requests have been finalized, the initiating user may then proceed to transmit these part-payment requests to the server 100 for distribution to each of the co-users. Once the server receives the part-payment request, the server will then communicate with each of the co-users based on an identifier such as the phone number previously provided by the initiating user. As shown in FIGS. 10A and 10B, a part-payment request 1002 may then appear on each of the co-users' Smartphone application after it has been sent from the server. In the example shown in FIG. 10A, it is shown a co-user has received an invitation or part payment request from an initiating user, “Jackie Lai” to pay a total of $1000 towards a group transaction. Also on the screen shot, it is shown that the co-user can proceed to utilize any rewards 1004 or pay any additional tips 1006 so as to adjust the part payment due to the group transaction. The co-user may also be able to change his or her credit card details 1008 for settling the part payment. Once any adjustments are made to each of these categories, the co-user can then select the “pay now” button 1010 to settle this part-payment.

As shown in FIG. 10B, the application operating on a smart phone or computing device is arranged to provide a status page 1012 to the initiating user and each of the co-users. In this example, statuses relating to each of the group purchases are presented, including the amount due for each of the part-payment requests, as well as the status of payment between each of the co-users. It is intended that the reminders 1014 for unpaid part payments are also presented to users based on the amount of time remaining to settle any part-payment requests.

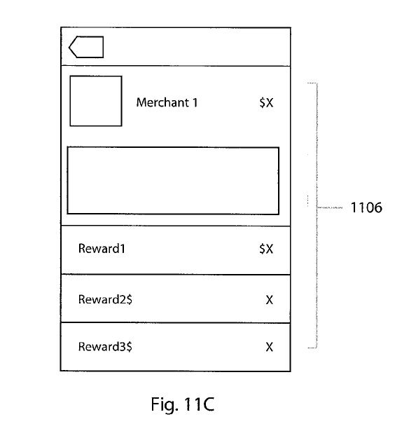

With reference to FIGS. 11A, 11B and 11C, there is illustrated a screen shot of a payment page of one example of the application for the system for facilitating a transaction. In this example embodiment, the payment details of each initiating user or co-user 1102 can be selected based on the number of different credit cards or banking details 1104 shown in FIG. 11B. Preferably, as the Smartphone will have a touch screen interface, the user can simply select the payment tab 1103 and be prompt with a number of different bank account or credit card details which have been previously entered 1104. Once any one of these credit card details are selected, the user may then be prompt to proceed to the screen shown in FIG. 11C which allows redemption of reward or loyalty programs or discount coupons 1106 to be utilized for this particular group transaction.

These embodiments are advantageous in that the part payment process can be simplified and integrated with any rewards and loyalty programs. By providing an interface which allows users to select between the rewards program and the selection of banking or credit card details, the application is made more attractive as it is intuitive and simple to use for any user, and thus minimizing the stress in managing a group transaction whilst also allowing a user to fully utilise any rewards, loyalty or bonus programs.

With reference to FIGS. 12A to 12D, there is provided a number of sample screen shots of a Smartphone application interface for an initiating user who has initiated a group payment and invited co-users to contribute towards this group transaction. As shown in FIG. 12A, a total amount for the group transaction 1202 is displayed for an initiating user. Once the initiating user has successfully initiated the group payment with his or her co-users, that is following an optional validation method whereby the initiating user's credit details have been checked to ensure that the initiating user is able to act as a guarantor for any outstanding part-payments not paid by the co-users, the initiating user can then proceed to settle his or her share as shown in FIG. 12C which in this example is a total of $300, determined by the total amount of $2500 being split amongst the initiating user and other co-users.

Also as shown in FIG. 12B, is a timer 1204 which shows the remaining amount of time for the co-users to settle their part-payment for the group transaction. FIG. 12C shows a confirmation of payment by the initiating user of his or her portion of the outstanding charges, however in the event that one or more co-users does not contribute towards their part-payment within the predetermined timeframe, in this case 24 hours, then an updated settlement screen is shown in FIG. 12D in which an outstanding amount of additional $600 have been charged to the initiating user to give a total of $900 paid. This outstanding amount has been determined in this example by the failure of one or more co-users in settling their part-payment within the predetermined period of time as shown in FIGS. 12B to 12D. There is an optional button on the interface 1206 which allows the user at any stage to send an invoice to one or more co-users to prompt them to settle this amount.

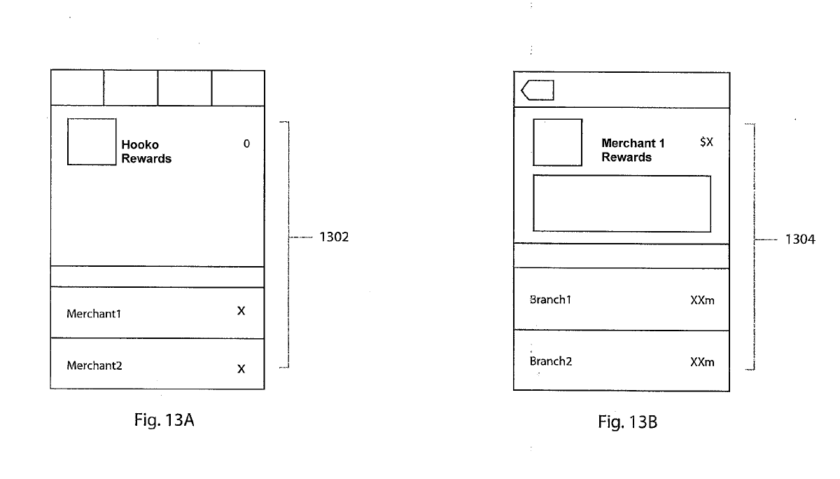

With reference to FIGS. 13A and 13B, there is illustrated an example of an interface of an Application operable for providing a system for facilitating a transaction including a rewards and loyalty program. In this example, a user, both an initiating user and a co-user, can access a rewards scheme via the application. As shown in FIG. 13A, different rewards programs 1302 may be uploaded onto this interface and can simply be applied to a group transaction. In addition to this rewards program as shown in FIG. 13B, different merchants can also contribute information 1304 relating to their own rewards program which can then be presented on an interface of the application for facilitating a group transaction.

In an alternative embodiment, the server 100 may operate to provide a payment service between a business and one or more customers. In this embodiment, the server 100 may be in communication with one or more businesses whereby the server is arranged to receive one or more payment requests from a business and upon receiving the payment requests, transmit these payment requests to one or more customers for settlement or retransmission to another party for part or full settlement.

In some embodiments, an additional advantage is provided in that a user can settle a payment request or push the payment request to others by a “one click” process. In these examples, as shown with reference to FIGS. 8A to 13B, the user can simply select a “express pay” button on the application interface (not shown) which will automatically process the steps to facilitate payment and/or push a payment request. Preferably, in order to facilitate this process of providing a single “click” express pay, preset details regarding payment facilities, co-users identity have already been stored. This is advantageous in that a user can simply select a “one click” button to process their payments without having to go through the various stages of setting up the pushing or payment of a payment request. In examples where a user regularly dines with the same group of friends, a single click payment button can assist the user in facilitate the settlement and push of a payment request without having to reenter the details of each co-user or merchant details.

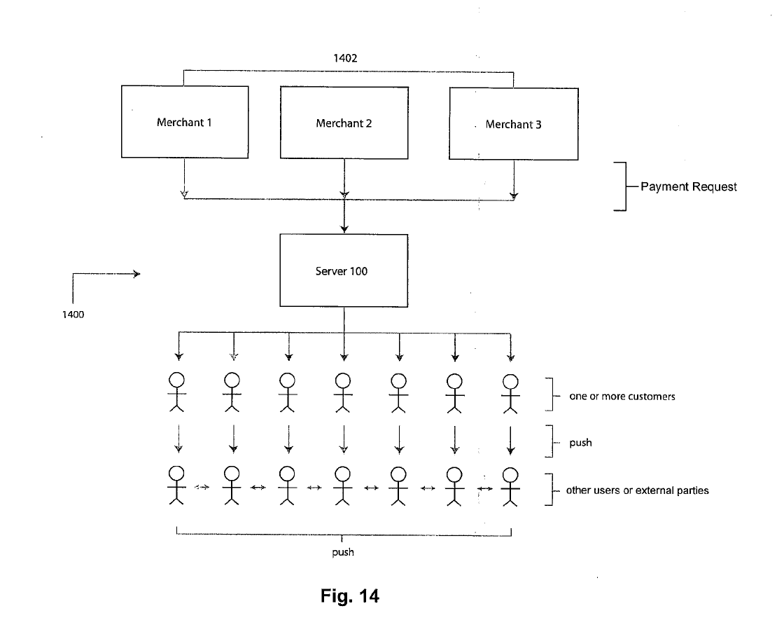

With reference to FIG. 14, there is provided a block diagram of an payment collection arrangement 1400 whereby an example of the server 100 is used to collate payment requests from and facilitate payments between one or more businesses or merchants to be sent to one or more customers. In this example embodiment, the server 100 may be in communication with a collection system 1402 of a business which needs to collect payment from a large pool of customers. The collection system 1402 may firstly contact the server 100 and provide the server 100 with information relating to a transaction as well as an initiating user's identity. After this information is received, the server 100 can then generate and transmit a payment request to an initiating user for settlement. As illustrated in some embodiments above, the initiating user, once having received the payment request may push the payment request to another party for settlement or part settlement, or proceed to settle the payment request him or herself.

These embodiments are advantageous in examples where a business has a large number of customers who would need to be contacted for payment collection. Businesses such as utility companies (e.g. electricity, gas, water, telephone or internet service providers) may regularly need to contact their customers to settle their outstanding invoices. In order to obtain and collect their payment, the businesses can contact the server 100 with the transaction details and allow the payment requests to be sent by the server 100, effectively allowing the server 100 to be a central point in payment processing. In examples where the transaction needs to be shared by more than one person or should be settled by another person, the payment requests generated by the server 100 is able to allow the payment requests to be pushed or shared amongst different users. In situations, for example, where a water bill is shared between three flatmates, the water utility company can send a payment request to one of the flatmates, after which, the flatmate can push a partial payment to one or more external parties (the other two flatmates or their parents/guardian) for part settlement. In the even that one or both of the other two flat mates do not settle the part payment, the flatmate that receive the payment request, effectively the initiating user, may act as a guarantor for the payment and be billed the outstanding amount.

Although not required, the embodiments described with reference to the Figures can be implemented as an application programming interface (API) or as a series of libraries for use by a developer or can be included within another software application, such as a terminal or personal computer operating system or a portable computing device operating system. Generally, as program modules include routines, programs, objects, components and data files assisting in the performance of particular functions, the skilled person will understand that the functionality of the software application may be distributed across a number of routines, objects or components to achieve the same functionality desired herein.

It will also be appreciated that where the methods and systems of the present invention are either wholly implemented by computing system or partly implemented by computing systems then any appropriate computing system architecture may be utilised. This will include stand alone computers, network computers and dedicated hardware devices. Where the terms “computing system” and “computing device” are used, these terms are intended to cover any appropriate arrangement of computer hardware capable of implementing the function described.

It will be appreciated by persons skilled in the art that numerous variations and/or modifications may be made to the invention as shown in the specific embodiments without departing from the spirit or scope of the invention as broadly described. The present embodiments are, therefore, to be considered in all respects as illustrative and not restrictive.

Any reference to prior art contained herein is not to be taken as an admission that the information is common general knowledge, unless otherwise indicated.

1. A system for facilitating a transaction comprising:
a payment gateway arranged to receive a group payment request arranged to identify a plurality of users each contributing a payment portion to a total balance of the transaction;
a generating module arranged to generate a part payment request for each of the plurality of users with the payment portion;
a payment interface arranged to transmit the part payment request to each of the plurality of users;
a settlement interface arranged to receive part payment instructions from each of the plurality of users to settle each of the part payment request;
a settlement module arranged to settle the part payment instructions to determine a combined settled amount; and,
a processor arranged to determining an outstanding balance by comparing the combined settled amount with the total balance and; whereupon an outstanding balance is determined, selecting a user from the plurality of users and settling the outstanding balance with the selected user.

2. A system in accordance with claim 1, wherein the plurality of users includes an initiating user and one or more co-users.

3. A system in accordance with claim 2, wherein the group payment request is received from the initiating user.

4. A system in accordance with claim 1, wherein the group payment request includes a plurality of identifiers each being associated with at least one of the plurality of users.

5. A system in accordance with claim 4, wherein the plurality of identifiers includes phone numbers.

6. A system in accordance with claim 4, wherein the group payment request includes details associated with the transaction.

7. A system in accordance with claim 1, wherein the part payment request includes the payment portion associated with each of the plurality of users.

8. A system in accordance with claim 1, wherein the part payment instructions includes a reference to the user's payment facility.

9. A system in accordance with claim 1, wherein the settlement interface further includes a routine arranged to contact a bank or financial institution to action the payment instruction.

10. A system in accordance with claim 3, wherein the selected user is the initiating user.

11. A system in accordance with claim 1, wherein the group payment request is received from a merchant.

12. A system for a merchant arranged to operate with a system in accordance with claim 1.

13. A method for facilitating a transaction comprising the steps of:
receiving a group payment request arranged to identify a plurality of users each contributing a payment portion to a total balance of the transaction;
generating a part payment request for each of the plurality of users with the payment portion;
transmitting the part payment request to each of the plurality of users;
receiving part payment instructions from each of the plurality of users to settle each of the part payment request;
settling the part payment instructions to determine a combined settled amount; and,
determining an outstanding balance by comparing the combined settled amount with the total balance and; whereupon an outstanding balance is determined, selecting a user from the plurality of users and settling the outstanding balance with the selected user.

14. A method in accordance with claim 13, wherein the plurality of users includes an initiating user and one or more co-users.

15. A method in accordance with claim 14, wherein the group payment request is received from the initiating user.

16. A system for facilitating a transaction comprising:
a payment gateway arranged to receive transaction information associated with a transaction between a merchant and an initiating user;
a generating module arranged to generate a payment request related to the transaction and
a payment interface arranged to transmit the payment request to the initiating user, wherein the payment request is arranged to be transferable to one or more co-users for settlement with a settlement interface.

17. A system in accordance with claim 16, wherein the payment request is transferred by the initiating user to the one or more co-users for settlement.

18. A system in accordance with claim 17, wherein the transaction information associated with the transaction includes a transaction identifier and a transaction amount.

19. A system in accordance with claim 18, wherein the transaction information associated with the transaction further includes an initiating user identifier arranged to identify the initiating user, a merchant identifier arranged to identify the merchant and a transaction amount.

20. A system in accordance with claim 19, wherein the payment request is generated to include the transaction information.

21. A system in accordance with claim 16, wherein the payment gateway is further arranged to obtain financial information from the initiating user; and, process the financial information to validate the initiating user in settling a transaction amount of the transaction.

22. A system in accordance with claim 21, wherein the settlement interface is arranged to
determine a difference between the transaction amount and an amount settled by the one or more co-users after a predetermined time period; and
settle the difference with the initiating user.

23. A method for facilitating payment comprising the steps of:
receiving one or more payment request from a merchant;
determining the identity of one or more users; and,
transmitting the one or more payment requests to the one or more users for settlement.

24. A method in accordance with claim 23, wherein the payment request is arranged to be transferable to one or more external parties.
